(19) United States
(12) Patent Application Publication
(10) Pub. No.: US 2011/0043606 A1
(43) Pub. Date: Feb. 24, 2011

(54) OMNI-DIRECTIONAL VIDEO CAMERA DEVICE

(76) Inventor: Kuo-Chang Yang, Taipei City (TW)

Correspondence Address: HDLS Patent & Trademark Services, P.O. BOX 220746, CHANTILLY, VA, 20153-0746, US

(21) Appl. No.: 12/713,589

(22) Filed: Feb. 26, 2010

(30) Foreign Application Priority Data
Aug. 20, 2009 (TW) 098215364

(51) Int. Cl. H04N 7/00

(52) U.S. Cl. 348/37; 348/E07.001

(57) ABSTRACT

An omni-directional video camera device includes a base portion (1), several moveable lenses (11), a rotational portion (3), a rotational cover portion (2), several moveable rotational lenses (21) and an electrical control device 4. The moveable lenses (11) are disposed in the base portion (1). The rotational cover portion (2) is disposed on top of the base portion (1). The moveable rotational lenses (21) are disposed in the rotational cover portion (2). The electrical control device (4) is disposed in the rotational cover portion (2). Therefore, the omni-directional video camera de vice may be used indoors, outdoors or in a motor vehicle. With the moveable lenses (11) and the moveable rotational lenses (21), the omni-directional video camera device can capture and record video images in the environment in an omni-directional manner.

### BACKGROUND OF THE INVENTION

1. Field of the Invention

The invention generally relates to an omni-directional video camera device. More particularly, the invention relates to an omni-directional video camera device that utilizes the moveable lenses and the moveable rotational lenses and can capture and record video images in an environment in an omni-directional manner.

2. Description of the Prior Art

The traditional video cameras are widely used in factories, dorms, stores, shops, apartment buildings and residential areas. They may be installed in the entries and exits, passageways and places where people rarely go to. The cameras can record video images in an environment. Therefore, these cameras can prevent and reduce crimes.

In the prior art, there are two types of video cameras (omni and pan-tilt). The omni camera may capture video images in a 360 degree manner and may utilize reflective mirrors. Therefore, images are often distorted and image processing software is often needed to correct the images. The pan-tilt camera can rotate to capture the images of interest; however, there are areas or angles that it can not cover.

To captures video images in an omni-directional manner without the distortion of images, several video cameras (each is installed in a different place to cover the full environment) may be needed. Therefore, cost and maintenance fees may be greatly increased. The omni-directional video camera device of the present invention has the advantages of several cameras.

To eliminate the disadvantages of the video cameras of the prior art, the inventor has put a lot of effort into the subject and has successfully come up with the omni-directional video camera device of the present invention.

### SUMMARY OF THE INVENTION

An object of the present invention is to provide an omni-directional video camera device that may be used in a motor vehicle to record the movement data of the vehicle.

Another object of the present invention is to provide an omni-directional video camera device that may be used inside and outside of a home to instantaneously display and record the conditions of the home.

A third object of the present invention is to provide an omni-directional video camera device that utilizes the moveable lenses and the moveable rotational lenses.

To reach these objects, the omni-directional video camera device of the present invention is disclosed. The omni-directional video camera device of the present invention comprises a base portion, several moveable lenses, a rotational portion, a rotational cover portion, several moveable rotational lenses and an electrical control device. At least a speaker is disposed on the base portion. The moveable lenses are disposed in the base portion. An audio signal capturing device may be fitted on each of the moveable lenses. The rotational portion is centrally disposed in the base portion. The rotational cover portion is disposed on top of the base portion. A small keyboard may be disposed on top of the rotational cover portion. An engagement hole (corresponding to the rotational portion) is centrally disposed in the rotational cover portion. The moveable rotational lenses are disposed in the rotational cover portion. A night vision unit may be fitted on each of the moveable rotational lenses. The electrical control device is disposed in the rotational cover portion. A slot for memory, a slot for electrical connection, a radio transmission element and an anti-theft element are provided in the base portion. The anti-theft element may be connected with the small keyboard disposed on top of the rotational cover portion.

### BRIEF DESCRIPTION OF THE DRAWINGS

FIG. 1 is a perspective exploded view illustrating the omni-directional video camera device the present invention.

FIG. 2 is a perspective view illustrating the omni-directional video camera device the present invention in an assembled condition.

FIG. 3A is a top view of the base portion of the device of the present invention.

FIG. 3B is a bottom view of the base portion of the device of the present invention.

FIG. 3C is a top view of the rotational cover portion of the device of the present invention.

FIG. 3D is a bottom view of the rotational cover portion of the device of the present invention.

FIG. 3E is a view showing how the moveable lens is configured.

FIG. 3F is a view showing how the moveable rotational lenses are configured.

FIG. 4 is a view showing the first embodiment of the present invention.

FIG. 5 is a view showing the second embodiment of the present invention.

### DETAILED DESCRIPTION OF THE PREFERRED EMBODIMENT

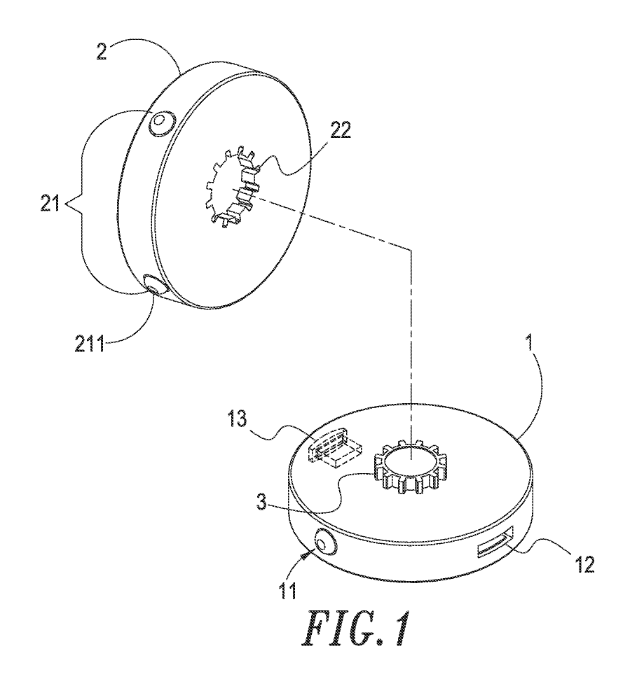

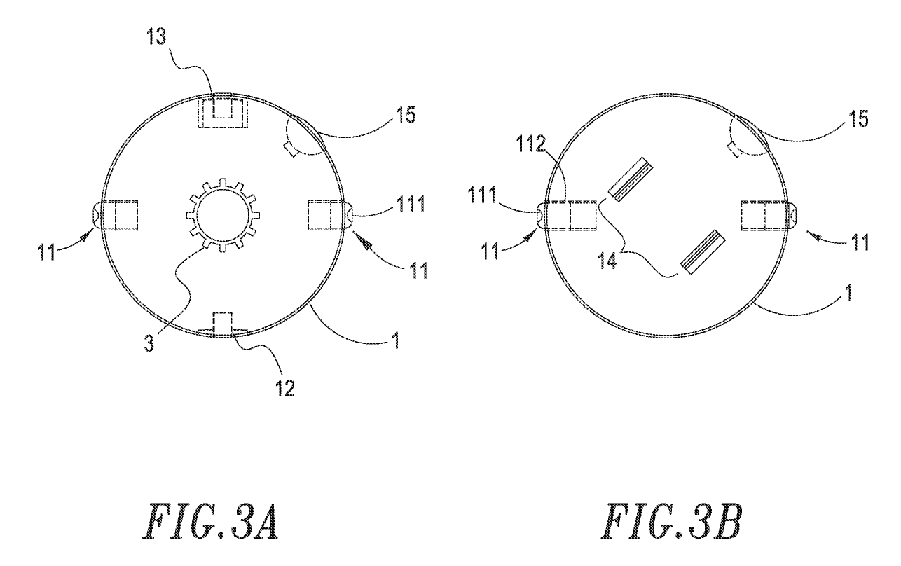

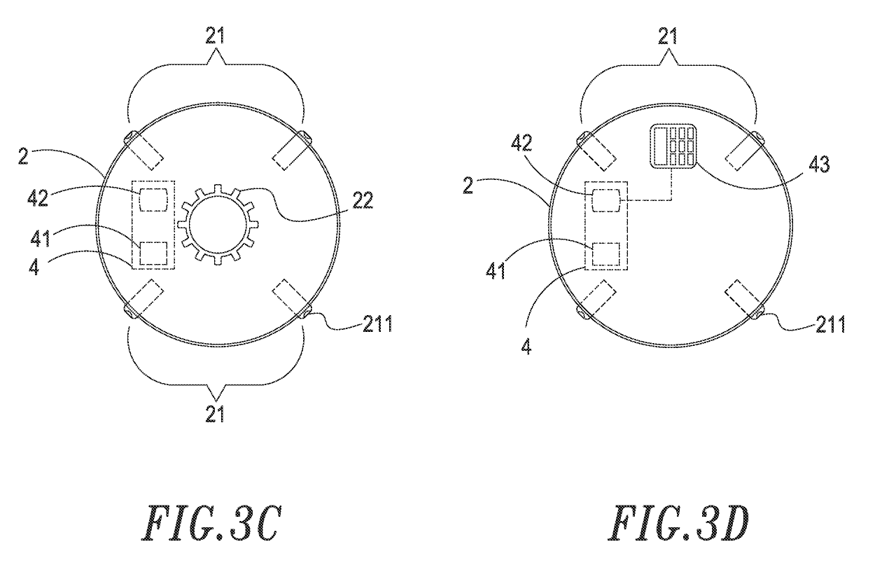

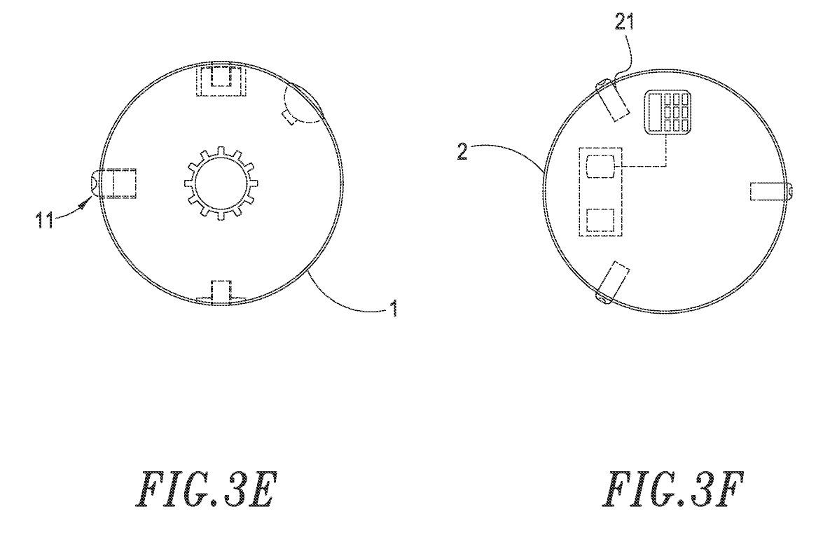

Please refer to FIG. 1, which illustrates a perspective exploded view of the omni-directional video camera device the present invention. The omni-directional video camera device of the present invention comprises a base portion 1, several moveable lenses 11, a rotational portion 3, a rotational cover portion 2, several moveable rotational lenses 21 and an electrical control device 4. At least a speaker 15 is disposed on the base portion 1 (please see FIG. 3B). The moveable lenses 11 are disposed in the base portion 1. The rotational portion 3 is centrally disposed in the base portion 1. The rotational cover portion 2 is disposed on top of the base portion 1. An engagement hole 22 (corresponding to the rotational portion 3) is centrally disposed in the rotational cover portion 2. The moveable rotational lenses 21 are disposed in the rotational cover portion 2. The electrical control device 4 (please see FIG. 3C) is disposed in the rotational cover portion 2. Therefore, the device of the present invention may be fitted indoor, outdoor or in a motor vehicle. With the moveable lenses 11 and the moveable rotational lenses 21, the device of the present invention can capture and record video images in an environment in an omni-directional manner. The device of the present invention may be installed in home to check on whether a patient is well taken cared of by the caretaker.

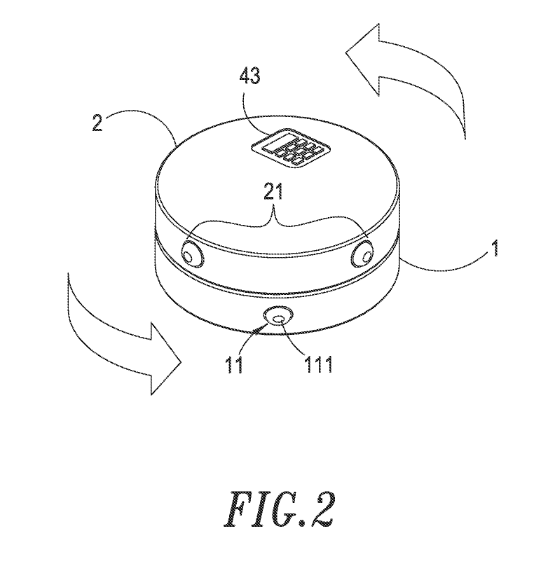

FIG. 2 is a perspective view illustrating the device of the present invention in an assembled condition. The rotational portion 3 (as shown in FIG. 1) and the engagement hole 22 (as shown in FIG. 1) allow the rotational cover portion 2 to rotate around on the base portion 1; therefore, such rotation allows the moveable rotational lenses 21 to capture and record video images in an environment in an omni-directional manner. In addition, a water-proof cover (not shown in the drawings) may be used to ensure the device of the present invention can work indoors and outdoors.

Please see FIGS. 3A (a top view of the base portion of the device of the present invention) and 3B (a bottom view of the base portion of the device of the present invention). A night vision unit 111 may be fitted on each of the moveable lenses 11 and an audio signal capturing device 112 may also be used. Therefore, the moveable lenses 11 can capture and record video images in a dark environment with the night vision units 111. Also, the audio signal capturing device 112 can capture sounds in the environment. In addition, the speaker 15 can give out directions and send out warning sounds in an emergency. A slot for electrical connection 12 and a slot for memory 13 are provided in the base portion 1. The slot for electrical connection 12 may be USB (universal serial bus) and may be connected with other electrical source, batteries, etc. to supply the electricity to the device of the present invention. A memory storage unit (not shown in the drawings) may be connected with the slot 13 to store the images and audio signals. The slot for electrical connection 12 and the slot for memory 13 may be connected wit the electrical control device 4 (as shown in FIG. 3C). In addition, the slot for electrical connection 12 may be connected with a UPS (uninterrupted power supply, not shown in the drawings) to ensure uninterrupted supply of electricity.

Please see FIGS. 3C (a top view of the rotational cover portion 2 of the device of the present invention) and 3D (a bottom view of the rotational cover portion 2 of the device of the present invention). A night vision unit 211 may be fitted on each of the moveable rotational lenses 21. Therefore, the moveable rotational lenses 21 can capture and record the images in a dark environment with the night vision units 211. The rotational portion 3 (as shown in FIG. 1) and the engagement hole 22 (as shown in FIG. 1) allow the rotational cover portion 2 to rotate around on the base portion 1. Therefore, such rotation allows the moveable rotational lenses 21 to capture and record video images in an environment in an omni-directional manner. In addition, a radio transmission element 41 and an anti-theft element 42 are disposed in the electrical control device 4.

The radio transmission element 41 can transmit files stored in a storage unit (not shown in the drawings) to a remote storage unit or a remote computer through RF (radio frequency), GPRS (general packet radio service), Bluetooth technology or wireless network. In addition, a user may use the web browser or image management software to manage the device of the present invention. In addition, other people may access the device of the present invention through authorization. Furthermore, if there is a trespasser, the device of the present invention would send out an email to the user or the speaker 15 (as shown in FIG. 3B) would send out a warning sound.

The anti-theft element 42 may be connected with a small keyboard (please see FIG. 3D) and a code may be so entered. The small keyboard is disposed on top of the rotational cover portion 2 (please see FIG. 2) and may be used to select functions and enter a code.

Please see FIG. 3E, which shows how the moveable lens 11 is configured. Only a moveable lens 11 is used and is used for a certain area.

Please see FIG. 3F, which shows how the moveable rotational lenses 21 are configured. Different numbers of the moveable rotational lenses 21 may be used.

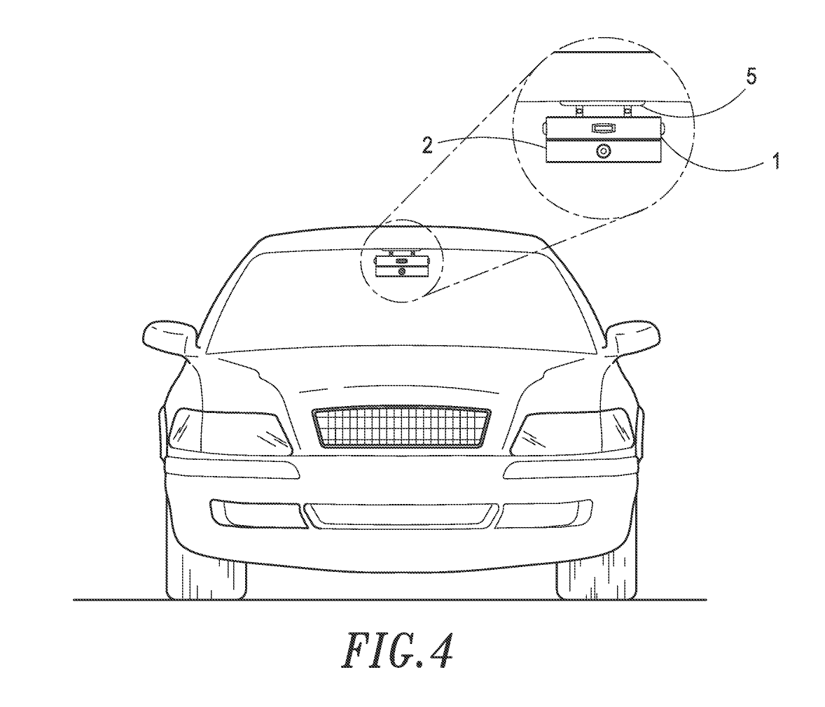

Please see FIG. 4, which shows the first embodiment of the present invention. When the device of the present invention is installed in a car, a seating unit 5 may be used to connect it to the roof. The seating unit 5 may engage with the connective slots 14 (as shown in FIG. 3B). Therefore, the device of the present invention can capture and record video images inside and outside the car and record the movement data of the vehicle. In addition, the device may adjust or modify image condition and avoid the upside-down condition. When the device of the present invention is installed in a public transportation, with the base portion and the rotational cover portion 2, the movement data of the public transportation and the conditions inside the public transportation may be recorded. When the device of the present invention is used for anti-theft, the anti-theft element 42 (please see FIG. 3C) may be connected with a small keyboard 43 (please see FIG. 3B) and a code may be so entered. If a user does not enter the correct code within 5 minutes after the car is started, the device of the present invention would activate a positioning system (not shown in the drawings) with the radio transmission element 41 (as shown in FIG. 3C) and the device of the present invention would call up the owner of the car. In such case, the owner must use a computer or a phone to cancel the alarm within 5 minutes; otherwise, a signal would be send to a security company or the police. After a period, the device of the present invention would send out warning sounds and shut off the car.

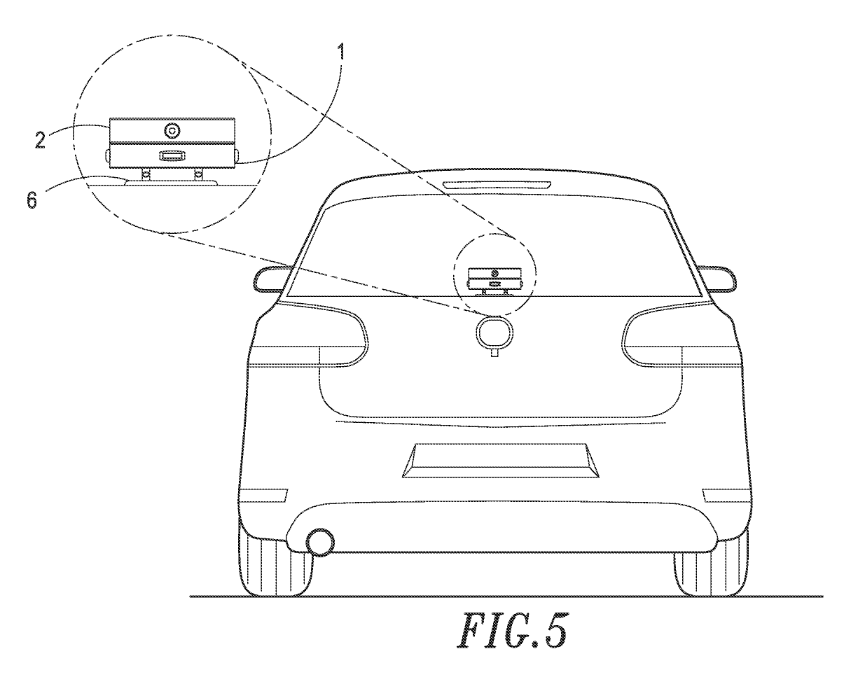

Please see FIG. 5, which shows the second embodiment of the present invention. When the device of the present invention is installed in a car, a supportive frame 6 may be used. The seating unit 5 may engage with the connective slots 14 (as shown in FIG. 3B). Because the frame 6 is moveable, the angle of the device of the present invention may be easily adjusted. The base portion 1 and the rotational cover portion 2 allow the device of the present invention to record the movement data of the car and the conditions inside and outside the car. If the device of the present invention is stolen, the device of the present invention would call up the owner of the car (when the device of the present invention is taken away from the car for a certain distance) through the radio transmission element 41 (as shown in FIG. 3C).

In comparison to the prior art, the device of the present invention has the following advantages:

1. When the device of the present invention is used in a motor vehicle, images are instantaneously displayed and the movement data of the vehicle may be recorded.

2. When the device of the present invention is used in a motor vehicle, images of the user's home and the conditions inside the user's home (whether a patent a well taken care of by a caretaker) may instantaneously displayed.

3. The moveable lenses and moveable rotational lenses allow the device of the present invention to capture and record video images in the environment in an omni-directional manner.

4. The device of the present invention allows a user to access the video images through the internet.

Although two preferred embodiments of the present invention have been described in detail in the above, the preferred embodiments and the associated discussion and drawings are to be regarded in an illustrative manner rather than a restrictive manner. It will, however, be evident that various changes and modifications may be made thereunto without departing from the broader spirit and scope of the invention as set forth in the appended claims.

What is claimed is:

1. An omni-directional video camera device, comprising:
a base portion, wherein at least a speaker is disposed on the base portion;
a plurality of moveable lenses, disposed in the base portion;
a rotational portion, centrally disposed in the base portion;
a rotational cover portion, disposed on top of the base portion, wherein an engagement hole corresponding to the rotational portion is centrally disposed in the rotational cover portion;
a plurality of moveable rotational lenses, disposed in the rotational cover portion; and
an electrical control device , disposed in the rotational cover portion.

2. The omni-directional video camera device as in claim 1, wherein connective slots may be provided on bottom of the base portion.

3. The omni-directional video camera device as in claim 1, wherein a slot for memory is disposed in the base portion and the slot is connected with the electrical control device.

4. The omni-directional video camera device as in claim 1, wherein a slot for electrical connection is disposed in the base portion and the slot is connected with the electrical control device.

5. The omni-directional video camera device as in claim 1, wherein a small keyboard may be disposed on top of the rotational cover portion.

6. The omni-directional video camera device as in claim 1, wherein an audio signal capturing device may be fitted on each of the moveable lenses.

7. The omni-directional video camera device as in claim 1, wherein a night vision unit may be fitted on each of the moveable lenses.

8. The omni-directional video camera device as in claim 1, wherein a night vision unit may be fitted on each of the moveable rotational lenses.

9. The omni-directional video camera device as in claim 1, wherein a radio transmission element is disposed in the electrical control device.

10. The omni-directional video camera device as in claim 1, wherein an anti-theft element is disposed in the electrical control device.
